(19) United States
(12) Patent Application Publication
(10) Pub. No.: US 2005/0200621 A1
(43) Pub. Date: Sep. 15, 2005

(54) Power supply device of LCD module, LCD module of regulating working voltage and method of regulating power supply of LCD module

(75) Inventor: Tsung Chieh Cho, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Arima Display Corporation, Kaoshiung (TW)

(21) Appl. No.: 10/800,552

(22) Filed: Mar. 15, 2004

(51) Int. Cl. G09G 5/00

(52) U.S. Cl. 345/211

(57) ABSTRACT

A power supply device of an LCD module, an LCD module of regulating working voltage and a method of regulating power supply of an LCD module are provided. The LCD module of regulating working voltage includes a power micro-regulating apparatus of an LCD module, an LCD display panel, a column driving circuit and a row driving circuit. A voltage following device is electrically connected to a second end of a plurality of dividing resistors. A regulating voltage is input to the dividing resistors via the second end to regulate a plurality of output working voltages. The cost of the LCD module product is cheaper and the output working voltage is easily regulated. The power supply device can be applied to all LCD module having different specifications. The circuit of the power supply device is simple and can be well easily controlled.

### FIELD OF THE INVENTION

The present invention relates to a power supply device of an LCD (liquid crystal display) module, an LCD module having a regulating working voltage and a method of regulating power supply of a LCD module, more particularly to ones which are utilized on a portable electrical apparatus.

### BACKGROUND OF THE INVENTION

The main marketing features of a portable electrical product, such as a cellular phone, personal digital assistant (PDA), smart phone, stock market machine are low working voltage and electrical power-saving. Although a small portion of the thin-film-transistor (TFT) product can meet the above requirements, most of the reflective TFT techniques consume more electrical energy than that of a STN techniques.

The conventional monochrome STN LCD is utilized in a portable electrical products of low prices. Because the displays of current cellular phones, PDAs are becoming colorful screens, the color STN LCD are applied. Therefore, for the displays of the portable products, such as PDAs, cellular phones, which do not display animations, the STN LCD can meet the requirements of low working voltage and electrical power-saving. A frontlight can be mounted on a reflective STN display to provide a light source when working in a dim environment. A backlight system for a semi-transparent STN display is used for assisting in lightening the environment. When the environment has enough light source, a reflective or semi-transparent display does not need to use the built-in frontlight and backlight light source saving electrical energy.

Please refer to FIG. 1. The conventional liquid crystal module 9 includes the rising voltage power circuit 90, the LCD display panel 93, the column driving circuit 94 and the row driving circuit 95. As illustrated in FIGS. 1 and 2, the rising voltage power circuit 90 includes the DC/DC converter 91 and the power bias fixing circuit 92. The DC/DC converter 91 converts an input voltage to a high output voltage needed by the liquid crystal module 9. The power bias fixing circuit 92 includes a divider circuit including five dividing resistors R91, R92, R93, R94, and R95 to generate six working voltages V0, V1, V2, V3, V4 and V5. The six working voltages V0, V1, V2, V3, V4 and V5 are driving voltages which are fixed and can not be changed for driving the liquid crystal display 93. The working voltages V0, V1, V4, and V5 are used in the column driving circuit 94 and the working voltages V0, V2, V3, and V5 are used in the row driving circuit 95. The rising voltage power circuit 90 has an input voltage VDD risen to a high level through the DC/DC converter 91 to generate a working voltage VEE needed by the power bias fixing circuit 92. Because of the match of the power bias fixing circuit 92 and the design of the micro-regulator Vcon (not shown), the IC manufacturer designed the rising voltage power circuit 90 into an integrated circuit (IC).

The IC has the following long-term drawbacks: (1) It is not convenient to change the design of the IC circuit. (2) The price of the IC is higher and the IC can not be substituted by another circuits in use. (3) Because the STN-LCD displays have different specifications, they need to utilize various rising voltage power circuits of ICs having different specifications. An output working voltage of one IC having a first specification may be accurate for that IC, but the output working voltage may not be accurate for another IC having a second specification. Thus, the wrong output working voltage results in poor brightness and poor color fidelity. Therefore, the IC product is not convenient in common usage.

In order to overcome the drawbacks in the prior art, a power supply device of an LCD module, an LCD module having a regulating working voltage and a method of regulating power supply of a LCD module are provided. In the particular design, the above problem is solved and the production cost is decreased greatly.

### SUMMARY OF THE INVENTION

It is an object of the present invention to provide a power supply device of an LCD module. The power supply device can be applied to all LCD module having different specifications.

It is another object of the present invention to provide an LCD module having a regulating working voltage. The cost of the LCD module product is cheaper and the output working voltage can be easily regulated.

It is a further object of the present invention to provide a method of regulating a power supply of an LCD module. The circuit of the power supply device is simple and can be easily controlled.

In accordance with an aspect of the present invention, a power supply device of an LCD module includes a plurality of dividing resistors electrically connected in series and having a first end and a second end, the first end being electrically connected to a direct-current power supply for generating an output working voltage between every two adjacent dividing resistors which is then outputted to the LCD module; and a voltage following device electrically connected to the second end of the dividing resistors for regulating the output working voltage through an input of a regulating voltage at the second end. The main means for solving the above problem is to electrically connect a voltage following device to a node of a fifth resistor. The voltage following device is electrically connected to the second end of the plurality of dividing resistors or dividing components. The regulating voltage is input into the second end in order to regulate the output working voltage.

Preferably, the voltage following device is a voltage follower including an operation amplifier.

Preferably, a converter is used as the direct-current power supply for converting an input voltage to a higher voltage to be used as the direct-current power supply.

Preferably, the converter is a DC/DC converter.

Preferably, the LCD module is an STN-LCD module.

In accordance with another aspect of the present invention, an LCD module having a regulating working voltage includes an LCD panel having a first substrate, a second substrate and a liquid crystal layer; a column driving circuit for generating column control signals to column drive the LCD panel; a row driving circuit for generating row control signals to row drive the LCD panel; and a power supply device of an LCD module for providing the working voltages to the column driving circuit and the row driving circuit. Because a regulating voltage which is input to the voltage following device is controlled and regulated, the power supply device can be mounted and applied to all kinds of STN-LCD modules and the production cost is decreased.

According to an aspect of the present invention, the power supply device of an LCD module includes a plurality of dividing resistors or dividing components electrically connected in series and having a first end and a second end, the first end being electrically connected to a direct-current power supply for generating an output working voltage between every two adjacent dividing resistors or dividing components which is then outputted to the LCD module; and a voltage following device electrically connected to the second end of the dividing resistors or dividing components for regulating the output working voltage through an input of a regulating voltage at the second end.

Preferably, the voltage following device is a voltage follower including an operation amplifier.

Preferably, a converter is used as the direct-current power supply for converting an input voltage to a higher voltage to be used as the direct-current power supply.

Preferably, the converter is a DC/DC converter.

Preferably, the LCD module is an STN-LCD module.

According to another aspect of the present invention, a power supply device of an LCD module includes a converter for converting a first voltage into a second voltage; a dividing components having a first end and a second end, the first end being electrically connected to the converter for generating a set of working voltages in response to the second voltage so as to be outputted to the LCD module; and a voltage following device electrically connected to the second end of the dividing components for regulating the set of working voltages through a provision of a regulating voltage.

Preferably, the dividing components includes a plurality of dividing resistors connected in series.

Preferably, an output working voltage is generated between every two adjacent dividing resistors.

According to a further aspect of the present invention, a method of regulating a power supply of an LCD module includes the following steps: (a) providing a first voltage; (b) converting the first voltage into a second voltage; (c) generating a set of output working voltages in response to the second voltage for being provided to the LCD module; and (d) providing a regulating voltage for regulating the set of output working voltages.

Preferably, the step (c) further includes the following steps: providing a set of dividing components; electrically connecting the second voltage to a first end of the dividing components; and outputting the set of output working voltages from the dividing components.

Preferably, the step (d) further includes the following steps: providing the regulating voltage; inputting the regulating voltage into a voltage following device to generate the regulating voltage; and inputting the regulating voltage into a second end of the dividing components to regulate the set of output working voltages.

The foregoing and other features and advantages of the present invention will be more clearly understood through the following descriptions with reference to the drawings, wherein:

### BRIEF DESCRIPTION OF THE DRAWINGS

FIG. 1 is a schematic view showing the conventional LCD module according to the prior art;

FIG. 2 is a circuit diagram showing the rising voltage power circuit according to the prior art;

FIG. 3 is a schematic view showing an LCD module according to a preferred embodiment of the present invention;

FIG. 4 is a circuit diagram showing a power bias micro-regulating circuit according to a preferred embodiment of the present invention;

FIGS. 5a, 5b and 5c are flowchart views showing the method of regulating power supply of an LCD module according to a preferred embodiment of the present invention; and

FIG. 6 is a diagram showing the detailed circuit of the LCD module according to a preferred embodiment of the present invention.

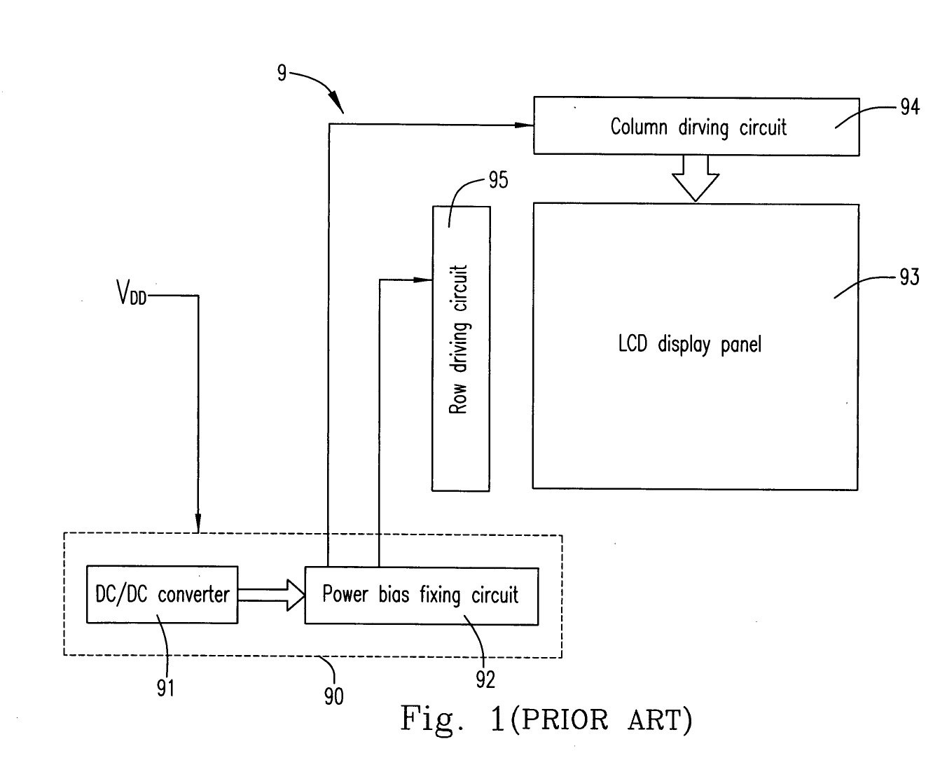

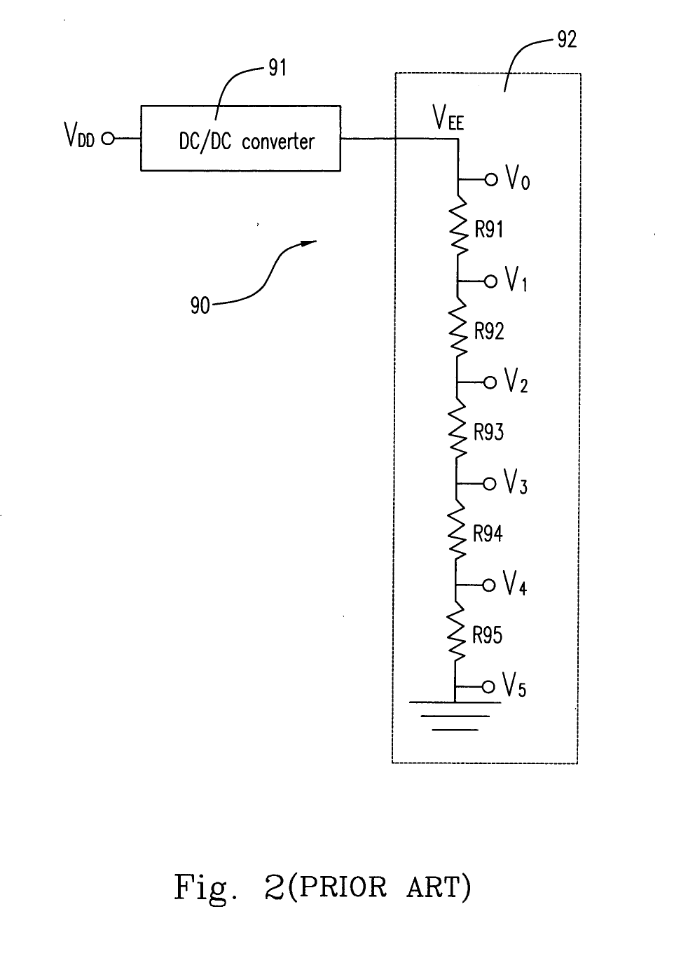

### DETAILED DESCRIPTION OF THE PREFERRED EMBODIMENT

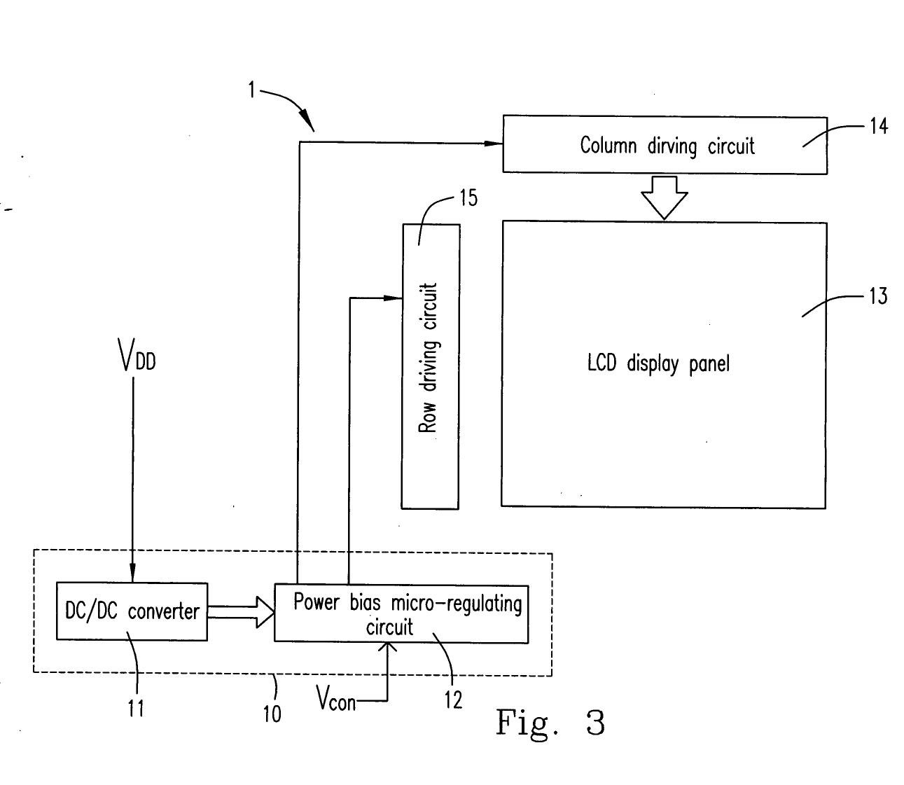

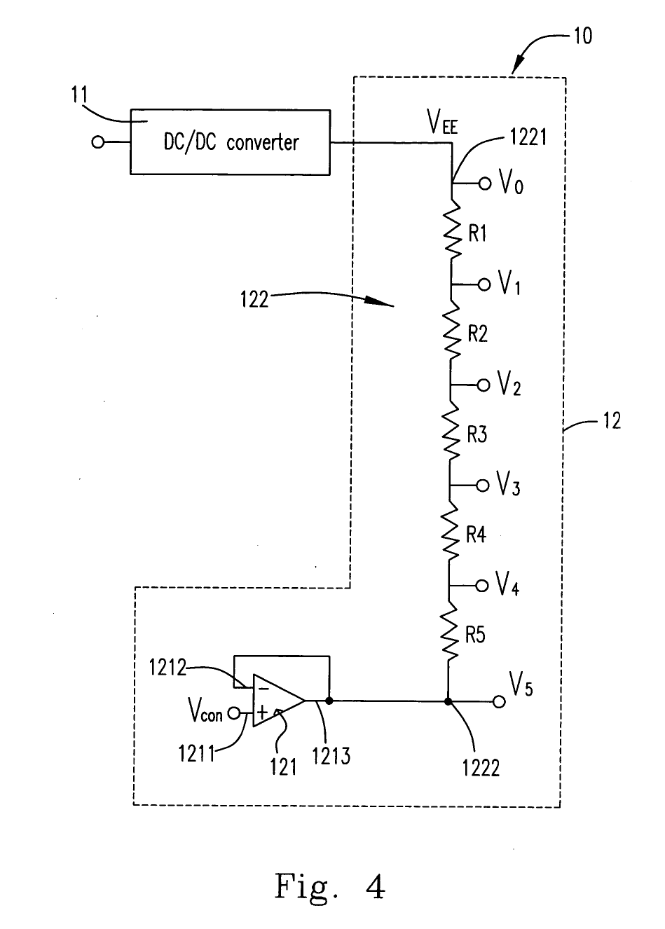

The present invention will now be described more specifically with reference to the following embodiments. Please refer to FIGS. 3 and 4, the LCD module of regulating working voltage provided in the present invention includes the power micro-regulating apparatus 10 of the LCD module 1, the LCD display panel 13, the column driving circuit 14 and the row driving circuit 15. The power micro-regulating apparatus 10 of the LCD module 1 includes the DC/DC converter 11 and the power bias micro-regulating circuit 12. The power micro-regulating apparatus 10 generates the regulating voltage Vcon regulated according to the types of various STN-LCD panels. A set of the regulated output working voltages V0, V1, V2, V3, V4 and V5 are output according to the specification and types of the LCD panels, in which the column driving circuit 14 uses the output working voltages V0, V1, V4 and V5, while the row driving circuits 15 uses the output working voltages V0, V2, V3 and V5. The output working voltages are provided to the column driving circuit 14 and the row driving circuit 15 for usage. In one preferred embodiment of the present invention, the regulating voltage Vcon can be, but is not limited to, about 2 volts.

In the present invention, the LCD panel 13 may be STN-LCD panel including, but is not limited to, monochrome, reflective or semi-transparent STN-LCD panels.

The power bias micro-regulating circuit 12 includes the voltage following device 121 and the dividing components 122. The dividing components 122 includes five dividing resistors R1, R2, R3, R4 and R5. In one preferred embodiment of the present invention, the voltage following device 121 can be a voltage follower including a operation amplifier. The regulating voltage Vcon is input into the positive-phase input terminal 1211. A negative-phase input terminal 1212 of the voltage following device 121 is electrically connected to an output terminal 1213. The output terminal 1213 is electrically coupled to the resistor R5.

The dividing components 122 consist of five resistors R1, R2, R3, R4 and R5. The voltage VEE at the first end 1221 is equal to V0. If the operation amplifier is an ideal one, the regulating voltage Vcon is equal to the output working voltage V5. The output working voltage V1 between the resistor R1 and the resistor R2, the output working voltage V2 between the resistor R2 and the resistor R3, the output working voltage V3 between the resistor R3 and the resistor R4, the output working voltage V4 between the resistor R4 and the resistor R5, and the output working voltage V5 between the resistor R5 and the regulating voltage Vcon are calculated and obtained by Ohm's law. Therefore, by regulating the regulating voltage Vcon, the output working voltage V0, V1, V2, V3, V4 and V5 are regulated stably by Ohm's law.

The output voltage VEE of the DC/DC converter 11 is generally, but is not limited to, 25 volts in the case of cellular phone, or PDA. The voltage drop across the first end 1221 and the second end 1222 of the dividing components 122 is equal to the value that VEE is subtracted by Vcon.

The DC/DC converter 11 can be commercially available from the market. For example, it can be LT1615, but is not limited to LT1615.

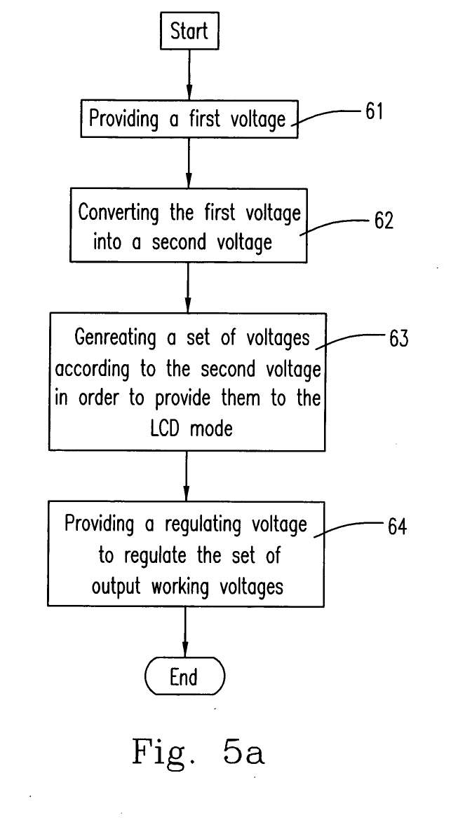

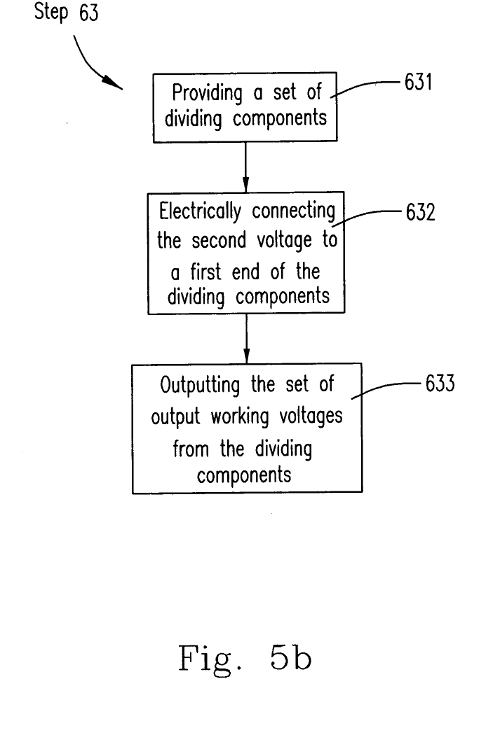

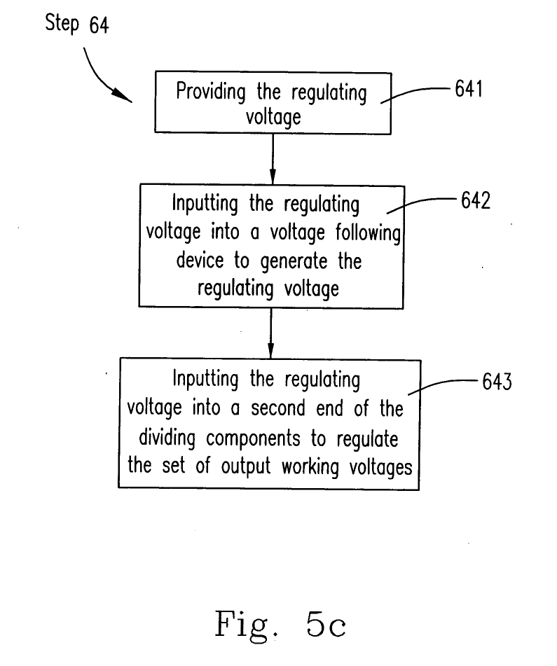

Please refer to FIGS. 5a, 5b and 5c which are flowcharts showing the method of regulating power supply of an LCD module according to the present invention. The method includes the following steps. In the Step 61, a first voltage is provided to the DC/DC converter 11. In the Step 62, the first voltage is converted into a second voltage VEE by means of the DC/DC converter 11 to output from the DC/DC converter 11. In the Step 63, a set of output working voltages V0, V1, V2, V3, V4 and V5 is generated according to the second voltage VEE in order to provide them to the LCD module. In the Step 64, a regulating voltage Vcon is provided to regulate the set of output working voltages V0, V1, V2, V3, V4 and V5.

In the Step 63, a set of output working voltages V0, V1, V2, V3, V4 and V5 is generated according to the second voltage VEE in order to provide them to the LCD module. The step further includes the following steps. In the Step 631, a set of dividing components 122 are provided. In the Step 632, the second voltage VEE is electrically connected to the first end 1221 of the dividing components 122. In the Step 633, the set of output working voltages V0, V1, V2, V3, V4 and V5 is outputted from the dividing components 122.

In the Step 64, a regulating voltage Vcon is provided to regulate the set of output working voltages V0, V1, V2, V3, V4 and V5. The step further includes the following steps. In Step 641, the regulating voltage Vcon is provided to the dividing components 122 and the voltage following device 121. In Step 642, the regulating voltage Vcon is input into the voltage following device 121 to generate the regulating voltage Vcon (because the input voltage is equal to the output voltage if the operation amplifier is an ideal one). In Step 643, the regulating voltage Vcon is input into the second end 1222 of the dividing components 122 to regulate the set of output working voltages V0, V1, V2, V3, V4 and V5.

The advantages of the present invention over prior art is that the production cost of the present invention is decreased 8-10%.

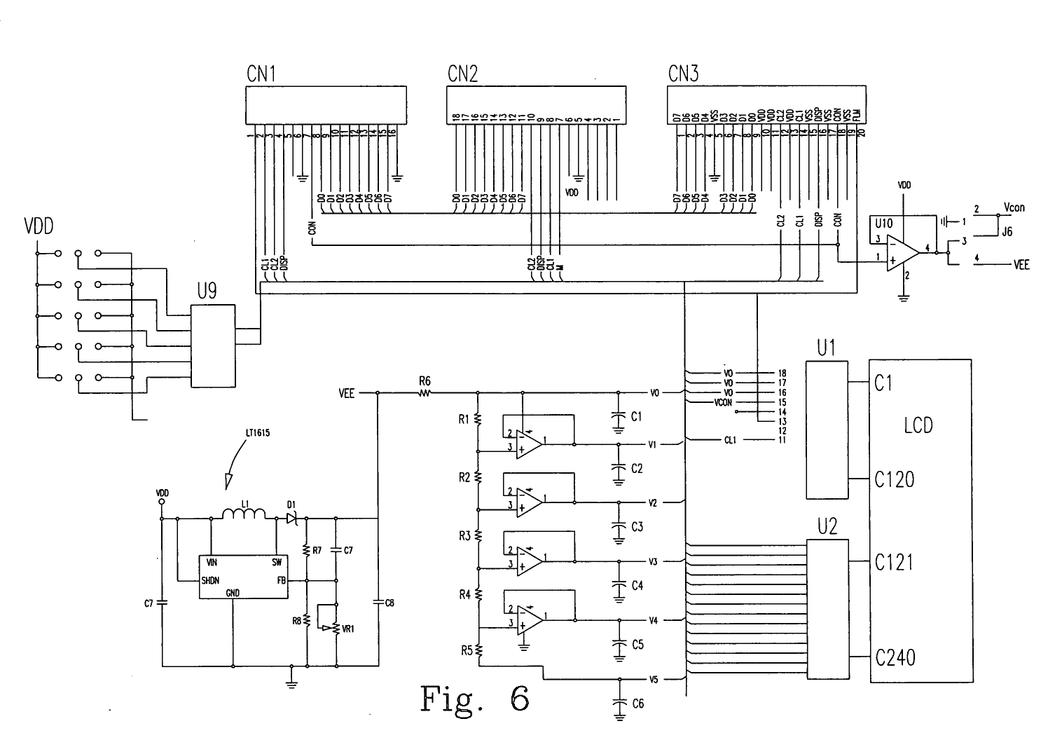

Please refer to FIG. 6 which is a detailed circuit diagram showing the LCD module according to a preferred embodiment of the present invention. The IC numbered as LT1615 is the DC/DC converter.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A power supply device of an LCD (liquid crystal display) module comprising:
a plurality of dividing resistors electrically connected in series and having a first end and a second end, said first end being electrically connected to a direct-current power supply for generating an output working voltage between every two adjacent dividing resistors which is then outputted to said LCD module; and
a voltage following device electrically connected to said second end of said dividing resistors for regulating said output working voltage through an input of a regulating voltage at said second end.

2. The power supply device according to claim 1, wherein said voltage following device is a voltage follower including an operation amplifier.

3. The power supply device according to claim 1, further comprising a converter for converting an input voltage into a higher voltage to be used as said direct-current power supply.

4. The power supply device according to claim 3, wherein said converter is a DC/DC converter.

5. The power supply device according to claim 1, wherein said LCD module is an STN-LCD module.

6. A LCD module having a regulating working voltage comprising:
an LCD panel having a first substrate, a second substrate and a liquid crystal layer;
a column driving circuit for generating a column control signal to column drive said LCD panel;
a row driving circuit for generating a row control signal to row drive said LCD panel; and
a power supply device as claimed in claim 1 for providing said working voltages to said column driving circuit and said row driving circuit.

7. The LCD module claimed in claim 6, wherein said power supply device of said LCD module comprises:
a plurality of dividing resistors electrically connected in series and having a first end and a second end, said first end being electrically connected to a direct-current power supply for generating output working voltage between every two adjacent dividing resistors which is then outputted to said LCD module; and
a voltage following device electrically connected to said second end of said dividing resistors for regulating said output working voltage through an input of a regulating voltage at said second end.

8. The LCD module as claimed in claim 7, wherein said voltage following device is a voltage follower including an operation amplifier.

9. The LCD module as claimed in claim 7, wherein a converter is used as said direct-current power supply for converting an input voltage to a higher voltage to be used as said direct-current power supply.

10. The LCD module as claimed in claim 9, wherein said converter is a DC/DC converter.

11. The LCD module as claimed in claim 7, wherein said LCD module is a STN-LCD module.

12. A power supply device of an LCD module comprising:
a converter for converting a first voltage into a second voltage;
a dividing components having a first end and a second end, said first end being electrically connected to said converter for generating a set of working voltages in response to said second voltage so as to be outputted to said LCD module; and
a voltage following device electrically connected to said second end of said dividing components for regulating said set of working voltages through a provision of a regulating voltage.

13. The power supply device as claimed in claim 12, wherein said dividing components comprises a plurality of dividing resistors connected in series.

14. The power supply device as claimed in claim 13, wherein an output working voltage is generated between every two adjacent dividing resistors.

15. A method of regulating a power supply of an LCD module, comprising the following steps:
(a) providing a first voltage;
(b) converting said first voltage into a second voltage;
(c) generating a set of output working voltages in response to said second voltage for being provided to said LCD module; and
(d) providing a regulating voltage for regulating said set of output working voltages.

16. The method as claimed in claim 15, wherein the step (c) further comprises the following steps:
providing a set of dividing components;
electrically connecting said second voltage to a first end of said dividing components; and
outputting said set of output working voltages from said dividing components.

17. The method as claimed in claim 16, wherein said step (d) further comprises the following steps:
providing said regulating voltage;
inputting said regulating voltage into a voltage following device to generate said regulating voltage; and
inputting said regulating voltage into a second end of said dividing components to regulate said set of output working voltages.
